(19) United States
(12) Patent Application Publication
(10) Pub. No.: US 2006/0224516 A1
(43) Pub. Date: Oct. 5, 2006

(54) METHOD OF PURCHASING DIGITAL WORKS, SUCH AS MUSIC, CONCERTS, MOVIES AND TELEIVISION SHOWS

(76) Inventors: Mark S. Lemon, Surrey, British Columbia (CA); James P. Robinson, Langley, British Columbia (CA)

Correspondence Address: VERMETTE & CO., BOX 40, GRANVILLE SQUARE, SUITE 230 - 200 GRANVILLE STREET, VANCOUVER, BC, V6C 1S4, CA

(21) Appl. No.: 11/161,106

(22) Filed: Jul. 22, 2005

Related U.S. Application Data
(63) Continuation-in-part of application No. 10/907,493, filed on Apr. 4, 2005.

(51) Int. Cl. G06Q 99/00

(52) U.S. Cl. 705/51

(57) ABSTRACT

method of distributing digital entertainment works at least partly over a global computer network, which includes providing a printed medium containing a code and identifying information relating to a digital entertainment work, distributing the item to a purchaser, and providing a website accessible over the Internet by the purchaser. In response to an input by the purchaser to the website, the input including the code and identifying information, the authenticity of the printed medium is verified and the digital entertainment work is transferred to the purchaser.

### RELATED APPLICATIONS

This is a Continuation in Part of U.S. patent application Ser. No. 10/907,493, filed Apr. 4, 2005.

### DESCRIPTION

1. Field

The present invention relates to a method of purchasing digital entertainment works, namely, digital music, movies, television shows, and concerts over a global computer network such as the Internet.

2. Background

Before being enjoined by the 9^{th} District Court, Napster experienced explosive growth in its business of facilitating others to transfer copyrighted digital music. While peer-to-peer file sharing has been held to be legal in both Canada and the U.S such activity is becoming increasingly limited and regulated (see for example, the recent U.S. Supreme Court Decision in MGM v. Grokster). Consequently, the door may soon close on those who obtain their music and movies free over the Internet.

It is possible to obtain digital music over the Internet through purchase with a credit card. However, teenagers and young adults, one of the biggest markets for such content, rarely have credit cards and so are limited in their ability to purchase legal content via the Internet.

Music stores offer CD's having a group of songs and are priced well above the cost of a single song. Consequently, anyone wishing to buy only one song must buy an entire album of songs.

Prepaid cards for purchasing digital music and video content over the Internet are known in the art. An identity number is provided for each card which, together with other information, allows the purchaser to set his/her own prepaid limit. However, the card must be used with a card reader/writer so that the available balance can be changed after each purchase and a personal identifier and a unique identifier can both be read and checked against records in a database to verify that the personal identifier presented matches a record on the database. The card is not specific to any one digital entertainment work but can be used to purchase one or more works within the database. In other cases a prepaid card is used without any code or personal identifier to purchase goods on a retail basis. An example is the current prepaid card sold by Starbucks (trade-mark). The card is presented for each purchase and a revised balance computed and stored on the card.

### SUMMARY OF THE INVENTION

According to the invention there is provided a method of distributing digital entertainment works at least partly over a global computer network, which includes providing a printed medium for sale, that contains a code and information identifying it with or linking it to a specific digital entertainment work or group of works for downloading from the internet. For the purposes of the present patent, printed medium refers to booklets, pamphlets, cards and posters.

The printed media contain information about a digital entertainment work, such as biographical information on the authors, creators, actors, and/or other persons involved in the creation of the work. The printed media could be similar to the liner notes inside a traditional CD case. Alternatively, the printed medium could take the form of a card, a poster, or a group of cards or posters.

Each printed medium contains a code and information identifying a specific digital entertainment work or group of works. The purchaser of a printed medium, upon accessing a website and inputting a code contained in the printed medium, is granted access to a transfer area of the website. In response to the purchaser requesting access to the transfer area of the website, inputting the code, and inputting information about the specific digital entertainment work(s) associated with the printed medium, the authenticity of the printed medium is verified and the purchaser allowed to transfer or download the digital entertainment work. If the purchaser enters an incorrect code or identifies the incorrect digital entertainment work(s), permission to download is denied.

The digital entertainment work may be selected from the group consisting of, for example, a song, a movie, a television show and a concert.

The transfer area of the website permits the transfer of the digital entertainment work(s) and is accessible only with the appropriate code(s) and/or identifying information.

Should the transferring step fail, the purchaser can be given additional opportunities to transfer the digital entertainment work(s) within a predetermined time.

Advantageously, the printed medium may contain information selected from the group consisting of artwork, images, photography, lyrics or biographical information, and may be given a distinctive design so as to make it collectible.

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a schematic diagram of the system used to carry out the method of the invention; and

FIG. 2 is a flow diagram of the method.

### DETAILED DESCRIPTION WITH REFERENCE TO THE DRAWINGS

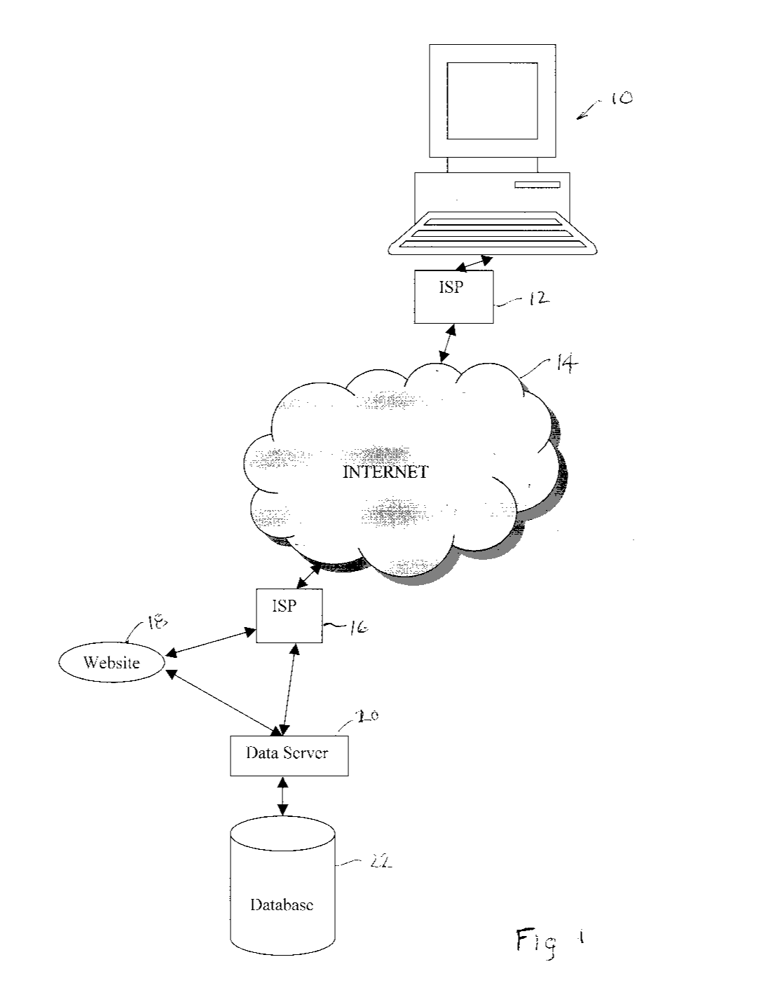

Referring to FIG. 1, a user computer 10 communicates through its ISP 12 to the Internet. A website 18 hosted by an ISP 16 receives the communications from the user computer 10 through its ISP 12 and a network such as the Internet 14. The website 18 contains a link that invites the user to transfer digital entertainment. If the link is clicked, the website 18 requests information as to the code of the printed medium, and identifying information related to the digital entertainment work, such as the name of the artist(s), author, principal actor/actress, director, etc. Upon receipt of the information and code, the website communicates with a data server 20 which accesses a database 22 and verifies that the printed medium is authentic. Once verified, the user 10 is informed that he can commence transferring the digital entertainment work(s) corresponding to the printed medium. In the event the transfer is unsuccessful due to such events as a service interruption, the user 10 may be given additional opportunities to transfer the digital entertainment work. A user 10 may be given 24 hours after a first unsuccessful attempt to transfer to make further attempts.

An additional revenue source may be obtained through advertising on the website 18 and on the printed media or on the packaging for the printed media or on inserts accompanying the printed media. The printed media may contain biographical information and/or pictures of the artist, author, starring actor, a list of movie content, and/or lyrics of the song. “Printed media” as used herein, refers to booklets, pamphlets, cards and posters. The printed media may be purchased at retail outlets, from vending machines, etc.

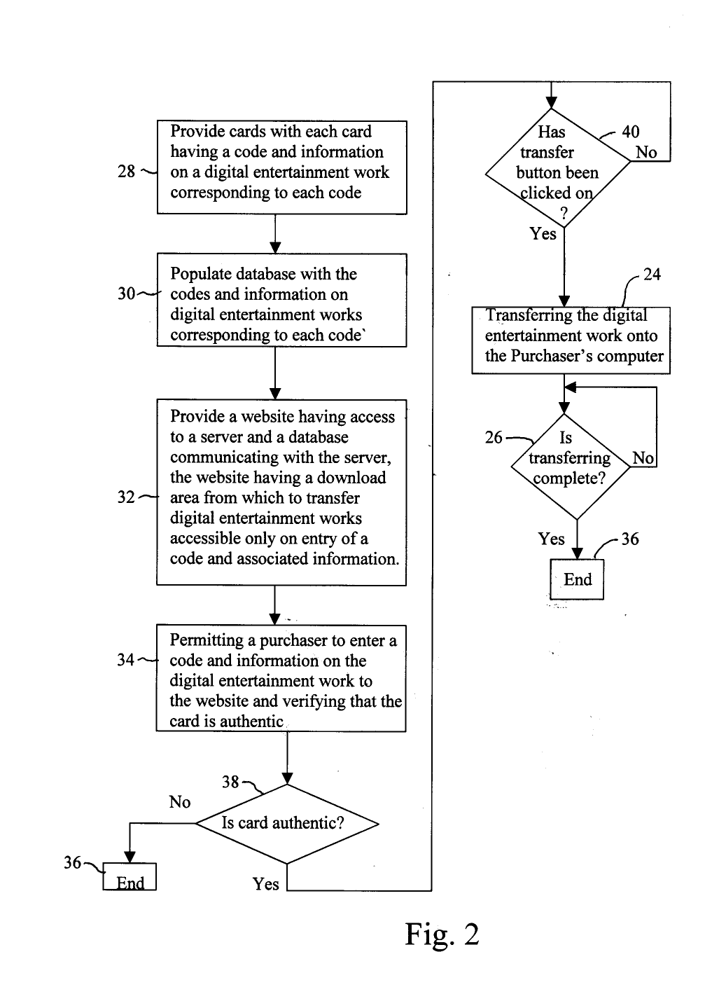

Referring to FIG. 2 the system includes the manufacture of printed media at step 28 which contain a code number on the printed media themselves or on the packaging for the printed media. In embodiments where the printed media are in the form of cards or posters, they may be accompanied by inserts containing information on the digital entertainment work(s), such as the name of the artist of a song and the lyrics, the title of the song, etc. The printed media and accompanying materials may be given unique designs to make them attractive as collectibles. The printed media may be sold for the price of a single song plus the value of the media. Alternatively, if the printed media each contain the codes for a number of audio, video or multimedia digital entertainment works, they can be sold for a price reflecting the value of those works. Alternatively, the printed media may be given away as part of a promotion (e.g. to promote a concert).

The database 22 is populated at step 30 with the codes, information relating to the authors, artists, creators, actors, etc. associated with the digital entertainment works, and the digital entertainment works themselves. A website associated with the printed media is provided and accessed at step 32 by the purchaser of a printed medium. A transfer link is clicked by the purchaser on the website 38 signifying that the purchaser wishes to transfer a digital entertainment work. In response, at step 34 the purchaser is invited to enter the code and information about the digital entertainment work that appears on or in the printed medium. Once entered, the data server 20 has a software program which accesses the database 22 to verify the accuracy of the data entered. If the data matches, then the printed medium is verified as authentic at step 38 and then step 40 is carried out. If the printed medium is determined not to be authentic then the program goes to step 36 where it is terminated. At step 40, if the purchaser has clicked the transfer link, then transferring begins at step 24. If not, then the system returns to the input of step 40. Once transferring onto the purchaser's computer has been completed, then at step 26 the system goes to the end at step 36.

The code may be part of the printed medium. Alternatively, it may be in the printed medium or applied to the printed medium as a sticker.

An advantageous feature of this system is that there is no financial transaction or requirement to ascertain a credit balance available on a card over the Internet. The only transaction that takes place over the Internet is the transferring of the digital entertainment work. Further there is no requirement for a card reader or other electromechanical device to read a card and update its information as only one prepaid transaction is involved.

It will be appreciated that the work required to protect against unauthorized use of a printed medium to obtain a single digital entertainment work is minimal. The combination of utilizing a code on the printed medium that is different for each printed medium and identifying information on that printed medium which is unique to the printed medium and/or corresponding digital entertainment work is likely to deter any unauthorized use. If a hacker does penetrate a code, he/she gains access to only a single digital entertainment work.

It will be appreciated that various modifications of the invention within the above teachings and purview of the appended claims are possible without departing from the spirit and intended scope of the invention.

What is claimed is:

1. A method of distributing digital entertainment works, comprising:
(a) providing a printed medium, the printed medium having a code and identifying information relating to a digital entertainment work;
(b) distributing said printed medium to a purchaser;
(c) providing a website having a transfer area, said website being accessible over the Internet by said purchaser;
(d) providing access to said purchaser to a transfer area of said website;
(e) in response to an input by said purchaser, transferring the digital entertainment work to the user;
wherein said input includes said code and said identifying information.

2. The method according to claim 1, wherein the digital entertainment work is selected from the group consisting of a song, a movie, a concert video, and a television show.

3. The method according to claim 1, wherein the digital entertainment work is a song and the printed medium contains said code and one or more items selected from the group consisting of artwork, images, photography, lyrics or biographical information about an artist of the song.

4. The method according to claim 1, wherein said transfer area is accessible only by inputting said code and said information.

5. The method according to claim 1, wherein said identifying information is a title of said digital entertainment work.

6. The method according to claim 1, wherein said printed medium is selected from the groups consisting of printed media, posters and cards.

7. The method according to claim 1, wherein said code and said identifying information are verified before said digital entertainment work is transferred to said user.

8. A method of distributing digital entertainment works, comprising:
(a) providing a packaged printed medium, one of the printed medium and the packaging containing a code and information relating to a digital entertainment work;
(b) distributing said printed medium to a purchaser;
(c) providing a website having a transfer area, said website and transfer area being accessible over the Internet by said purchaser;
(d) in response to an input by said purchaser, transferring the digital entertainment work to the user;
wherein said input includes said code and said identifying information; and
wherein said input is verified prior to transferring said digital entertainment work by comparing said code and said identifying information against a database.

9. The method according to claim 8, wherein the digital entertainment work is selected from the group consisting of a song, a movie, a concert video and a television show.

10. The method according to claim 8, including providing a purchaser a second opportunity to transfer within 24 hours of a first unsuccessful attempt.

11. A method of distributing digital entertainment works, comprising:
(a) providing a plurality of printed media, each of said printed media containing a code and identifying information relating to a digital entertainment work associated;
(b) distributing said printed media to one or more purchasers;
(c) populating a database with said digital entertainment works, said codes and said identifying information;
(d) providing a website, said website being accessible over the Internet by said purchasers;
(e) in response to an inputs by said purchasers, said input including said codes and said identifying information, verifying authenticity of said printed media; and
(f) transferring said digital entertainment works to said purchasers.

12. The method according to claim 11, wherein said website is accessible only with said codes and said identifying information.

13. The method according to claim 11, wherein if said transferring step fails, providing said purchasers additional opportunities to transfer said digital entertainment works.
